(19) United States
(12) Patent Application Publication
(10) Pub. No.: US 2012/0016960 A1
(43) Pub. Date: Jan. 19, 2012

(54) MANAGING SHARED CONTENT IN VIRTUAL COLLABORATION SYSTEMS

(76) Inventors: Daniel G. Gelb, Redwood City, CA (US); Ian N. Robinson, Pebble Beach, CA (US); Kar-Han Tan, Santa Clara, CA (US)

(21) Appl. No.: 13/259,750

(22) PCT Filed: Apr. 16, 2009
(86) PCT No.: PCT/US2009/040868

§ 371 Date: Sep. 23, 2011

(51) Int. Cl. G06F 15/16

(52) U.S. Cl. 709/217

(57) ABSTRACT

Systems and methods for modifying content of a media stream (24) based on a user's one or more gestures are disclosed. A node (22) configured to transmit a media stream (24) having content to one or more other nodes includes a media device (36) configured to capture an image of one or more gestures of a user of the node (22); a media analyzer (38) configured to identify the one or more gestures from the captured image; and a node manager (44) configured to modify the content of the media stream (24) based, at least in part, on the identified one or more gestures,

### BACKGROUND

Videoconferencing and other forms of virtual collaboration allow the real-time exchange or sharing of video, audio, and/or other content or data among systems in remote locations. That real-time exchange of data may occur over a computer network in the form of streaming video and/or audio data.

In many videoconferencing systems, media streams that include video and/or audio of the participants are displayed separately from media streams that include shared content, such as electronic documents, visual representations of objects, and/or other audiovisual data. Participants interact with that shared content by using peripheral devices, such as a mouse, keyboard, etc. Typically, only a subset of the participants is able to interact or control the shared content.

### BRIEF DESCRIPTION OF THE DRAWINGS

FIG. 1 is a block diagram of a virtual collaboration system in accordance with an embodiment of the disclosure.

FIG. 2 is a block diagram of a node in accordance with an embodiment of the disclosure.

FIG. 3 is an example of a node with a feedback system and examples of gestures that may be identified by the node in accordance with an embodiment of the disclosure.

FIG. 4 is a partial view of the node of FIG. 3 showing another example of a feedback system in accordance with an embodiment of the disclosure.

FIG. 5 is a flow chart showing a method of modifying content of a media stream based on a user's one or more gestures in accordance with an embodiment of the disclosure.

### DETAILED DESCRIPTION

The present illustrative methods and systems may be adapted to manage shared content in virtual collaboration systems. Specifically, the present illustrative systems and methods may, among other things, allow modification of the shared content via one or more actions (such as gestures) of the users of those systems. Further details of the present illustrative virtual collaboration systems and methods will be provided below.

As used in the present disclosure and in the appended claims, the terms “media” and “content” are defined to include text, video, sound, images, data, and/or any other information that may be transmitted over a computer network.

Additionally, as used in the present disclosure and in the appended claims, the term “node” is defined to include any system with one or more components configured to receive, present, and/or transmit media with a remote system directly and/or through a network. Suitable node systems may include videoconferencing studio(s), computer system(s), personal computer(s), notebook computer(s), personal digital assistant(s) (PDAs), or any combination of the previously mentioned or similar devices.

Similarly, as used in the present disclosure and in the appended claims, the term “event” is defined to include any designated time and/or virtual meeting place providing systems a framework to exchange information. An event allows at least one node to transmit and receive media information and/or media streams. An event also may be referred to as a “session.”

Further, as used in the present disclosure and in the appended claims, the term “topology” is defined to include each system associated with an event and its respective configuration, state, and/or relationship to other systems associated with the event. A topology may include node(s), event focus(es), event manager(s), virtual relationships among nodes, mode of participation of the node(s), and/or media streams associated with the event.

Moreover, as used in the present illustrative disclosure, the terms “subsystem” and “module” may include any number of hardware, software, firmware components, or any combination thereof. As used in the present disclosure, the subsystems and modules may be a part of and/or hosted by one or more computing devices, including server(s), personal computer(s), personal digital assistant(s), and/or any other processor containing apparatus. Various subsystems and modules may perform differing functions and/or roles and together may remain a single unit, program, device, and/or system.

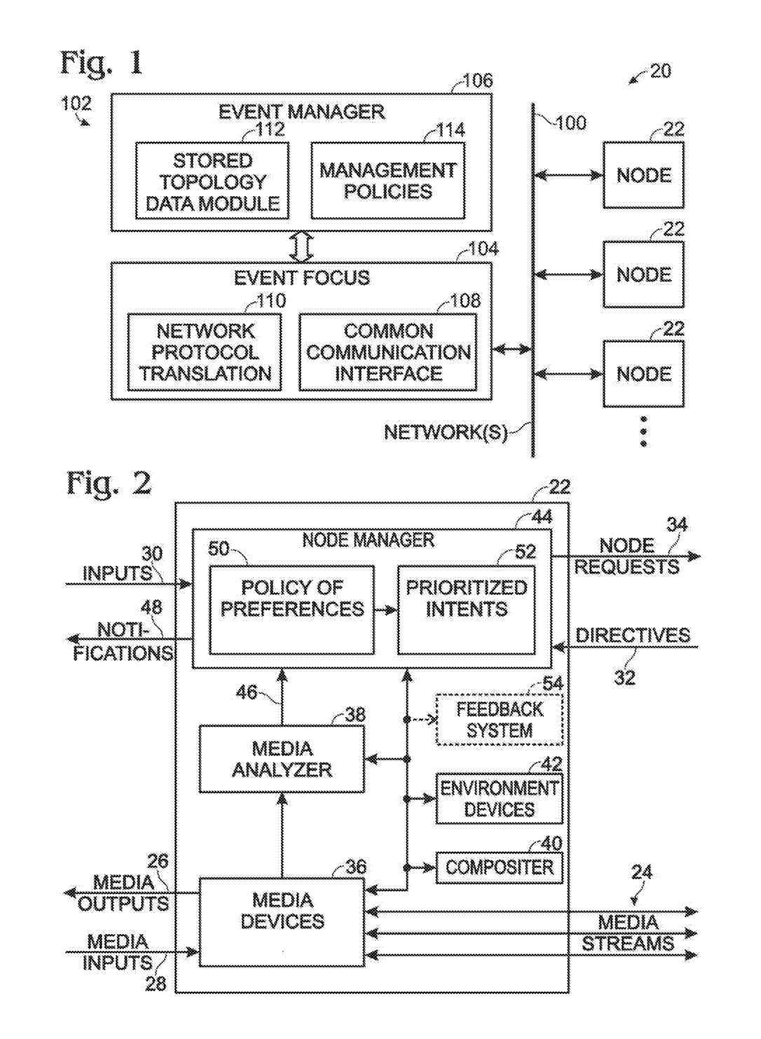

FIG. 1 shows a virtual collaboration system 20. The virtual collaboration system may include a plurality of nodes 22 connected to one or more communication networks 100, and a management subsystem or an event manager system 102. Although virtual collaboration system 20 is shown to include event manager system 102, the virtual collaboration system may, in some embodiments, not include the event manager system, such as in a peer-to-peer virtual collaboration system. In those embodiments, one or more of nodes 22 may include component(s) and/or function(s) of the event manager system described below.

Network 100 may be a single data network or may include any number of communicatively coupled networks. Network 100 may include different types of networks, such as local area network(s) (LANs), wide area network(s) (WANs), metropolitan area network(s), wireless network(s), virtual private network(s) (VPNs), Ethernet network(s), token ring network(s), public switched telephone network(s) (PSTNs), general switched telephone network(s) (GSTNs), switched circuit network(s) (SCNs), integrated services digital network(s) (ISDNs), and/or proprietary network(s).

Network 100 also may employ any suitable network protocol for the transport of data including transmission control protocol/internet protocol (TCP/IP), hypertext transfer protocol (HTTP), file transfer protocol (FTP), T.120, Q.931, stream control transmission protocol (SCTP), multi-protocol label switching (MPLS), point-to-point protocol (PPP), real-time protocol (RTP), real-time control protocol (RTCP), real-time streaming protocol (RTSP), and/or user datagram protocol (UDP).

Additionally, network 100 may employ any suitable call signaling protocols or connection management protocols, such as Session Initiation Protocol (SIP) and H.323. The network type, network protocols, and the connection management protocols may collectively be referred to as “network characteristics.” Any suitable combination of network characteristics may be used.

The event manager system may include any suitable structure used to provide and/or manage one or more collaborative “cross-connected” events among the nodes communicatively coupled to the event manager system via the one or more communication networks. For example, the event manager system may include an event focus 104 and an event manager 106.

FIG. 1 shows the elements and functions of an exemplary event focus 104. The event focus may be configured to perform intermediate processing before relaying requests, such as node requests, to event manager 106. Specifically, the event focus may include a software module capable of remote communication with the event manager of one or more of nodes 22.

Event focus 104 may include a common communication interface 108 and a network protocol translation 110, which may allow the event focus to receive node requests from one or more nodes 22, translate those requests, forward the requests to event manager 106 and receive instructions from the event manager, such as media connection assignments and selected intents (discussed further below).

Those instructions may be translated to directives by the event focus for transmission to selected nodes. The module for network protocol translation 110 may employ encryption, decryption, authentication, and/or other capabilities to facilitate communication among the nodes and the event manager.

The use of event focus 104 to forward and process requests to the event manager may eliminate a need for individual nodes 22 to guarantee compatibility with potentially unforeseen network topologies and/or protocols. For example, the nodes may participate in an event through various types of networks, which may each have differing capabilities and/or protocols. The event focus may provide at least some of the nodes with a common point of contact with the event. Requests from nodes 22 transmitted to event focus 104 may be interpreted and converted to a format and/or protocol meaningful to event manager 106.

FIG. 1 also shows the components of an exemplary event manager 106. The event manager may communicate with the event focus directly. However, the event manager may be communicatively coupled to the event focus via a communication network. Regardless of the nature of the communication between the event focus and the event manager, the event manager may include a data storage module or stored topology data module 112 and a plurality of management policies 114. The stored topology data module associated with the event manager may describe the state and/or topology of an event, as perceived by the event manager. That data may include the identity of nodes 22 participating in an event, the virtual relationships among the nodes, the intent or manner in which one or more of the nodes are participating, and the capabilities of one or more of the nodes.

Event manager 106 also may maintain a record of prioritized intents for one or more of nodes 22. An intent may include information about relationships among multiple nodes 22, whether present or desired. Additionally, an intent may specify a narrow subset of capabilities of node 22 that are to be utilized during a given event in a certain manner. For example, a first node may include three displays capable of displaying multiple resolutions. An intent for the first node may include a specified resolution for media received from a certain second node, as well as the relationship that the media streams from the second node should be displayed on the left-most display. Additionally, event manager 106 may optimize an event topology based on the intents and/or combinations of intents received.

Event manager 106 may be configured to receive node requests from at least one event focus. The node requests may be identical to the requests originally generated by the nodes, or may be modified by the event focus to conform to a certain specification, interface, or protocol associated with the event manager.

The event manager may make use of stored topology data 112 to create new media connection assignments when node 22 requests to join an event, leave an event, or change its intent. Prioritized intent information may allow the event manager to assign media streams most closely matching at least some of the attendee's preferences. Additionally, virtual relationship data may allow the event manager to minimize disruption to the event as the topology changes, and node capability data may prevent the event manager from assigning media streams not supported by an identified node.

When a change in topology is requested or required, the event manager may select the highest priority intent acceptable to the system for one or more of the nodes 22 from the prioritized intents. The selected intent may represent the mode of participation implemented for the node at that time for the specified event. Changes in the event or in other systems participating in the event may cause the event manager to select a different intent as conditions change. Selected intents may be conditioned on any number of factors including network bandwidth or traffic, the number of other nodes participating in an event, the prioritized intents of other participating nodes and/or other nodes scheduled to participate, a policy defined for the current event, a pre-configured management policy, and/or other system parameters.

Management policies 114 associated with the event manager may be pre-configured policies, which, according to one example, may specify which nodes, and/or attendees are permitted to join an event. The management policies may additionally, or alternatively, apply conditions and/or limitations for an event including a maximum duration, a maximum number of connected nodes, a maximum available bandwidth, a minimum-security authentication, and/or minimum encryption strength. Additionally, or alternatively, management policies may determine optimal event topology based, at least in part, on node intents.

The event manager may be configured to transmit a description of the updated event topology to event focus 104. That description may include selected intents for one or more of nodes 22 as well as updated media connection assignments for those nodes. The formation of media connection assignments by the event manager may provide for the optimal formation and maintenance of virtual relationships among the nodes.

Topology and intent information also may be used to modify the environment of one or more of nodes 22, including the media devices not directly related to the transmission, receipt, input, and/or output of media. Central management by the event manager may apply consistent management policies for requests and topology changes in an event. Additionally, the event manager may further eliminate potentially conflicting configurations of media devices and media streams.

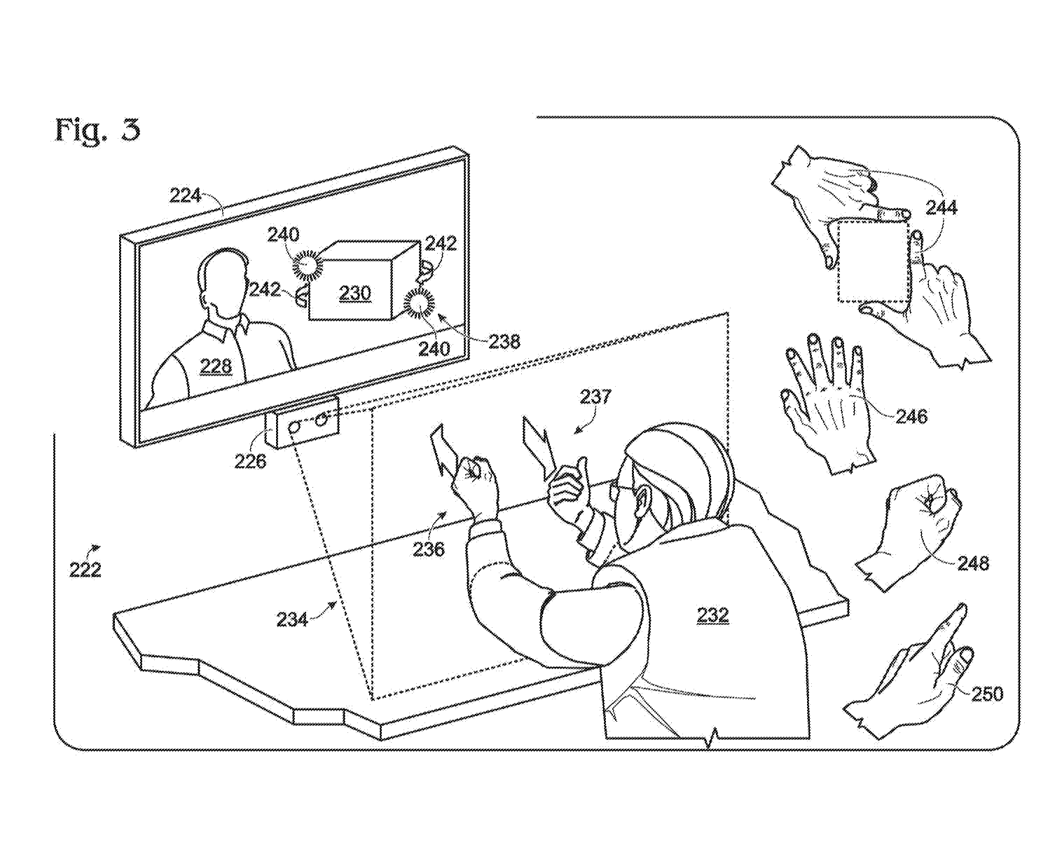

FIG. 2 shows components of a node 22, as well as connections of the node to event management system 102. As generally illustrated, node 22 is a system that may participate in a collaborative event by receiving, presenting, and/or transmitting media data. Accordingly, node 22 may be configured to receive and/or transmit media information or media streams 24, to generate local media outputs 26, to receive media inputs 28, attendee inputs 30, and/or system directives 32, and/or to transmit node requests 34. For example, node 22 may be configured to transmit one or more media streams 24 to one or more other nodes 22 and/or receive one or more media streams 24 from the one or more other nodes.

The media stream(s) may include content (or shared content) that may be modified by one or more of the nodes. The content may include any data modifiable by the one or more nodes. For example, content may include an electronic document, a video, a visual representation of an object, etc.

The physical form of node 22 may vary greatly in capability, and may include personal digital assistant(s) (PDAs), personal computer(s), laptop(s), computer system(s), video conferencing studio(s), and/or any other system capable of connecting to and/or transmitting data over a network. One or more of nodes 22 that are participating in an event may be referenced during the event through a unique identifier. That identifier may be intrinsic to the system, connection dependent (such as an IP address or a telephone number), assigned by the event manager based on event properties, and/or decided by another policy asserted by the system.

As shown, node 22 may include any suitable number of media devices 36, which may include any suitable structure configured to receive media streams 24, display and/or present the received media streams (such as media output 26), generate or form media streams 24 (such as from media inputs 28), and/or transmit the generated media streams. In some embodiments, media streams 24 may be received from and/or transmitted to one or more other nodes 22.

Media devices 36 may be communicatively coupled to various possible media streams 24. Any number of media streams 24 may be connected to the media devices, according to the event topology and/or node capabilities. The coupled media streams may be heterogeneous and/or may include media of different types. The node may simultaneously transmit and/or receive media streams 24 comprising audio data only, video and audio, video and audio from a specified camera position, collaboration data, shared content, and/or other content from a computer display to different nodes participating in an event.

Media streams 24 connected across one or more networks 100 may exchange data in a variety of formats. The media streams or media information transmitted and/or received may conform to coding and decoding standards including G.711, H.261, H.263, H.264, G.723, Mpeg1, Mpeg2, Mpeg4, VC-1, common intermediate format (CIF), and/or proprietary standard(s). Additionally, or alternatively, any suitable computer-readable file format may be transmitted to facilitate the exchange of text, sound, video, data, and/or other media types.

Media devices 36 may include any hardware and/or software element(s) capable of interfacing with one or more other nodes 22 and/or one or more networks 100. One or more of the media devices may be configured to receive media streams 24, and/or to reproduce and/or present the received media streams in a manner discernable to an attendee. For example, node 22 may be in the form of a laptop or desktop computer, which may include a camera, a video screen, a speaker, and a microphone as media devices 36. Alternatively, or additionally, the media devices may include microphone(s), camera(s), video screen(s), keyboard(s), scanner(s), motion sensor(s), and/or other input and/or output device(s).

Media devices 36 may include one or more video cameras configured to capture video of the user of the node, and to transmit media streams 24 including that captured video. Media devices 36 also may include one or more microphones configured to capture audio, such as one or more voice commands from a user of a node. Additionally, or alternatively, media devices 36 may include computer vision subsystems configured to capture one or more images, such as one or more three-dimensional images. For example, the computer vision subsystems may include one or more stereo cameras (such as arranged in stereo camera arrays) and/or one or more cameras with active depth sensors. Alternatively, or additionally, the computer vision subsystems may include one or more video cameras.

The computer vision subsystems may be configured to capture one or more images of the user(s) of the node. For example, the computer vision subsystems may be configured to capture images within one or more gestures (such as hand gestures) of the user of the node. The images may be two or three-dimensional images. The computer vision subsystems may be positioned to capture the images at any suitable location(s). For example, the computer vision subsystems may be positioned adjacent to a screen of the node to capture images at one or more interaction regions spaced from the screen, such as a region of space in front of the user(s) of the node. The computer vision subsystems may be positioned such that the interaction region does not include the screen of the node.

Node 22 also may include at least one media analyzer or media analyzer module 38, which may include any suitable structure configured to analyze output(s) from one or more of the media device(s) and identify any instructions or commands from those output(s). For example, media analyzer 38 may include one or more media stream capture mechanisms and one or more signal processors, which may be in the form of hardware and/or software/firmware.

The media analyzer may, for example, be configured to identify one or more gestures from the captured image(s) from one or more of the media devices. Any suitable gestures, including one or two-hand gestures (such as hand gestures that do not involve manipulation of any peripheral devices), may be identified by the media analyzer. For example, a framing gesture, which may be performed by a user placing the thumb and forefinger of each hand at right angles to indicate the corners of a display region (or by drawing a closed shape with one or more fingers), may be identified to indicate where the user wants to display content.

Additionally, a grasping gesture, which may be performed by a user closing one or both palms, may be identified to indicate that the user wants to grasp one or two portions of the content for further manipulation. Follow-up gestures to the grasping gesture may include a rotational gesture, which may be performed by keeping both palms closed and moving the arms to rotate the palms, may be identified to indicate that the user wants to rotate the content.

Additional examples of gestures that may be identified by the media analyzer include a reaching gesture, which may be performed by moving an open hand toward a particular direction, may be identified to indicate that the user wants to move the content to a particular area. Also, a slicing gesture, which may be performed by a user flattening out a hand and moving it downward, may be identified to indicate that the user wants to dissect a portion of the content. Additionally, a pointing gesture, which may be performed by a user extending his or her pointing finger, may be identified to indicate that the user wants to highlight one or more portions of the content.

Moreover, a paging gesture, which may be performed by a user extending his or her pointing finger and moving it from left to right or right to left, may be identified to indicate that the user wants to move from one shared content to another shared content (when multiple shared content are available, which may be displayed simultaneously or independently). Furthermore, a drawing or writing gesture, which may be performed by moving one or more fingers to draw and/or write on the content, may be identified to indicate that the user wants to draw and/or write on the shared content, such as to annotate the content.

Additionally, a “higher” gesture, which may be performed by a user opening the palm toward the ceiling and raising and lowering the palm, may be identified to indicate that the user wants to increase certain visual and/or audio parameter(s). For example, that gesture may be identified to indicate that the user wants to increase brightness, color, etc. of the shared content. Additionally, the higher gesture may be identified to indicate that the user wants audio associated with the shared content to be raised, such as a higher volume, higher pitch, higher bass, etc. Moreover, a “lower” gesture, which may be performed by a user opening the palm toward the floor and raising and lowering the palm, may be identified to indicate that the user wants to decrease certain visual and/or audio parameter(s). For example, that gesture may be identified to indicate that the user wants to decrease brightness, color, etc. of the shared content. Additionally, the lower gesture may be identified to indicate that the user wants audio associated with the shared content to be lowered, such as a lower volume, lower pitch, lower bass, etc.

Furthermore, where other nodes have left and right speakers, the user may use the left and/or right hands to independently control the audio coming from those speakers using the gestures described above and/or other gestures. Other examples may additionally, or alternatively, be identified by the media analyzer, including locking gestures, come and/or go gestures, turning gestures, etc.

Additionally, media analyzer 38 may be configured to identify one or more voice commands from the captured audio. The voice commands may supplement and/or complement the one or more gestures. For example, a framing gesture may be followed by a voice command stating that the user wants the content to be as big as the framing gesture is indicating. A moving gesture moving content to a certain location may be followed by a voice command asking the node to display the moved content at a certain magnification. Additionally, a drawing gesture that adds text to the content may be followed by a voice command to text recognize what was drawn.

The media analyzer may include any suitable software and/or hardware/firmware. For example, the media analyzer may include, among other structure, visual and audio recognition software and a relational database. The visual recognition software may use a logical process for identifying the gesture(s). For example, the visual recognition software may separate the user's gestures from the background. Additionally, the software may focus on the user's hands (such as hand pose, hand movement, and/or orientation of the hand) and/or other relevant parts of the user's body in the captured image. The visual recognition software also may use any suitable algorithm(s), including algorithms that process pixel data, block motion vectors, etc. The audio recognition software may focus on specific combinations of words.

The relational database may store recognized gestures and voice commands and to provide the associated interpretations of those gestures and commands as media analyzer inputs to a node manager, as further discussed below. The relational database may be configured to store additional recognized gestures and/or voice commands learned during operation of the media analyzer. The media analyzer may be configured to identify any suitable number of gestures and voice commands. Examples of media analyzers include gesture control products from GestureTek®, such as GestPoint®, GestureXtreme®, and GestureTek Mobile™, natural interface products from Softkinetic, such as iisu™ middleware, and gesture-based control products from Mgestyk Technologies, such as the Mgestyk Kit.

The computer vision subsystems and/or media analyzer may be activated in any suitable way(s) during operation of node 22. For example, the computer vision subsystems and/or media analyzer may be activated by a user placing something within the interaction region of the computer vision system, such as the user's hands. Although media analyzer 38 is shown to be configured to analyze media streams generated at local node 22, the media analyzer may additionally, or alternatively, be configured to analyze media streams generated at other nodes 22. For example, images of one or more gestures from a user of a remote node may be transmitted to local node 22 and analyzed by media analyzer 38 for subsequent modification of the shared content.

Node 22 also may include at least one compositer or compositer module 40, which may include any suitable structure configured to composite two or more media streams from the media devices. In some embodiments, the compositer may be configured to composite captured video of the user of the node with other content in one or more media streams 24. The compositing of the content and the video may occur at the transmitting node and/or the receiving node(s).

Node 22 also may include one or more environment devices 42, which may include any suitable structure configured to adjust the environment of the node and/or support one or more functions of one or more other nodes 22. The environment devices may include participation capabilities not directly related to media stream connections. For example, environment devices 42 may change zoom setting(s) of one or more cameras, control one or more video projectors (such as active, projected content being projected back onto the user and/or the scene), change volume, treble, and/or base settings of the audio system, and/or adjust lighting.

As shown in FIG. 2, node 22 also may include a node manager 44, which may include any suitable structure adapted to process attendee input(s) 30, system directive(s) 32, and/or media analyzer input(s) 46, and to configure one or more of the various media devices 36 and/or compositer 40 based, at least in part, on the received directives and/or received media analyzer inputs. The node manager may interpret inputs and/or directives received from the media analyzer, one or more other nodes, and/or event focus and may generate, for example, device-specific directives for media devices 36, compositer 40, and/or environment devices 42 based, at least in part, on the received directives.

For example, node manager 44 may be configured to modify content of a media stream to be transmitted to one or more other nodes 22 and/or received from those nodes based, at least in part, on the media analyzer inputs. Additionally, or alternatively, the node manager may be configured to modify content of a media stream transmitted to one or more other nodes 22 and/or received from those nodes 22 based, at least in part, on directives 32 received from those nodes. In some embodiments, the node manager may be configured to move, dissect, construct, rotate, size, locate, color, shape, and/or otherwise manipulate the content, such as a visual representation of object(s) or electronic document(s), based, at least in part, on the media analyzer input(s). Alternatively, or additionally, the node manager may be configured to modify how the content is displayed at the transmitting and/or receiving nodes based, at least in part, on the media analyzer input(s).

In some embodiments where the content is composited within video of the user(s) of the nodes, the node manager may be configured to provide directives to the compositer to modify how the content is displayed within the video based, at least in part, on the media analyzer inputs. For example, node manager 44 may be configured to modify a display size of the content within the video based, at least in part, on the media analyzer inputs. Additionally, or alternatively, the node manager may be configured to modify a position of a display of the content within the video based, at least in part, on the media analyzer inputs.

The node manager also may be configured to change the brightness, color(s), contrast, etc. of the content within the video based, at least in part, on the media analyzer inputs. Additionally, when there are multiple shared content, the node manager may be configured to make some of that content semi-transparent based, at least in part, on the media analyzer inputs (such as when a user performs a paging gesture described above to indicate which content should be the focus of attention of the users from the other nodes). Moreover, the node manager may be configured to change audio settings and/or other environmental settings of node 22 and/or other nodes based, at least in part, on the media analyzer inputs.

Configuration of the media devices and/or the level of participation may be varied by the capabilities of the node and/or variations in the desires of user(s) of the node, such as provided by user input(s) 30. The node manager also may send notifications 48 that may inform users and/or attendees of the configuration of the media devices, the identity of other nodes that are participating in the event and/or that are attempting to connect to the event, etc.

As discussed above, the various modes of participation may be termed intents, and may include n-way audio and video exchange, audio and high-resolution video, audio and low-resolution video, dynamically selected video display, audio and graphic display of collaboration data, audio and video receipt without transmission, and/or any other combination of media input and/or output. The intent of a node may be further defined to include actual and/or desirable relationships present among media devices 36, media streams 24, and other nodes 22, which may be in addition to the specific combination of features and/or media devices 36 already activated to receive and/or transmit the media streams. Additionally, or alternatively, the intent of a node may include aspects that influence environment considerations. For example, the number of seats to show in an event, which may, for example, impact zoom setting(s) of one or more cameras.

As shown in FIG. 2, the node manager also may include a pre-configured policy of preferences 50 within the node manager that may create a set of prioritized intents 52 from the possible modes of participation for the node during a particular event. The prioritized intents may change from event to event and/or during an event. For example, the prioritized intents may change when a node attempts to join an event, leave an event, participate in a different manner, and/or when directed by the attendee.

As node 22 modifies its prioritized intents 52, node requests 34 may be sent to the event manager system and/or other nodes 22. The node request may comprise one or more acts of connection. Additionally, the node request may include the prioritized intents and information about the capabilities of the node transmitting the node request. Moreover, the node request may include one or more instructions generated by the node manager based, at least in part, on the media analyzer inputs. For example, the node request may include instructions to the media device(s) of the other nodes to modify shared content, and/or instructions to the environment device(s) of the other nodes to modify audio settings and/or other environmental settings at those nodes. Furthermore, the node request may include the node type and/or an associated token that may indicate relationships among media devices 36, such as the positioning of three displays to the left, right, and center relative to an attendee.

A node may not automatically send the same information about its capabilities and relationships in every situation. Node 22 may repeatedly select and/or alter the description of capabilities and/or relationships to disclose. For example, if node 22 includes three displays but the center display may be broken or in use, the node may transmit information representing only two displays, one to the right and one to the left of an attendee. Thus, the information about a node's capabilities and relationships that event manager may receive may be indicated through the node type and/or the node's prioritized intents 52. The node request may additionally, or alternatively, comprise a form of node identification.

In some embodiments, node 22 also may include a feedback module or feedback system 54, which may include any suitable structure configured to provide visual and/or audio feedback of the one or more gestures to the user(s) of the node. For example, the feedback system may receive captured video of the one or more gestures from one or more media devices 36, generate the visual and/or audio feedback based on the captured video, and transmit that feedback to one or more other media devices 36 to output to the user(s) of the node. Feedback system 54 may generate any suitable visual and/or audio feedback. For example, the feedback system may overlay as a faded or “ghostly” version of the user (or portion(s) of the user) over the screen so that the user may see his or her gestures.

Additionally, or alternatively, feedback system 54 may be configured to provide visual and/or audio feedback of the one or more gestures identified or recognized by media analyzer 38 to the user(s) of the node. For example, the feedback system may receive input(s) from the media analyzer, generate the visual and/or audio feedback based on those inputs, and/or transmit that feedback to one or more other media devices 36 to output to the user(s) of the node. Feedback system 54 may generate any suitable visual and/or audio feedback. For example, the feedback system may display in words (such as “frame,” “reach in,” “grasp,” and “point”) and/or graphics (such as direction arrows and grasping points) the recognized gestures.

Although node 22 has been shown and discussed to be able to recognize gestures and/or voice commands of the user and modify content based on those gestures and/or commands, the node may additionally, or alternatively, be configured to recognize other user inputs, such as special targets that may be placed within the interaction region of the computer vision system. For example, special targets or glyphs may be placed within the interaction region for a few seconds to position content. The node also may recognize the target and may place the content within the requested area, even after the special target has been removed from the interaction region.

An example of node 22 is shown in FIG. 3 and is generally indicated at 222. Unless otherwise specified, node 222 may have at least some of the function(s) and/or component(s) of node 22. Node 222 is in the form of a videoconferencing studio that includes, among other media devices, at least one screen 224 and at least one depth camera 226. Displayed on the screen is a second user 228 from another node and shared content 230. The shared content is in the form of a visual representation of an object, such as a cube. Depth camera 226 is configured to captures image(s) of a first user 232 within an interaction region 234.

First user 232 is shown in FIG. 3 making gestures 236 (such as rotational gesture 237) within interaction region 234. On screen 224, visual feedback 238 is displayed such that the first user can verify that rotational gesture 237 has been identified and/or recognized by node 222. The visual feedback is in the form of sun graphics 240 that show where the first user has grasped the shared content, and directional arrows 242 that show which direction the first user is rotating the shared content.

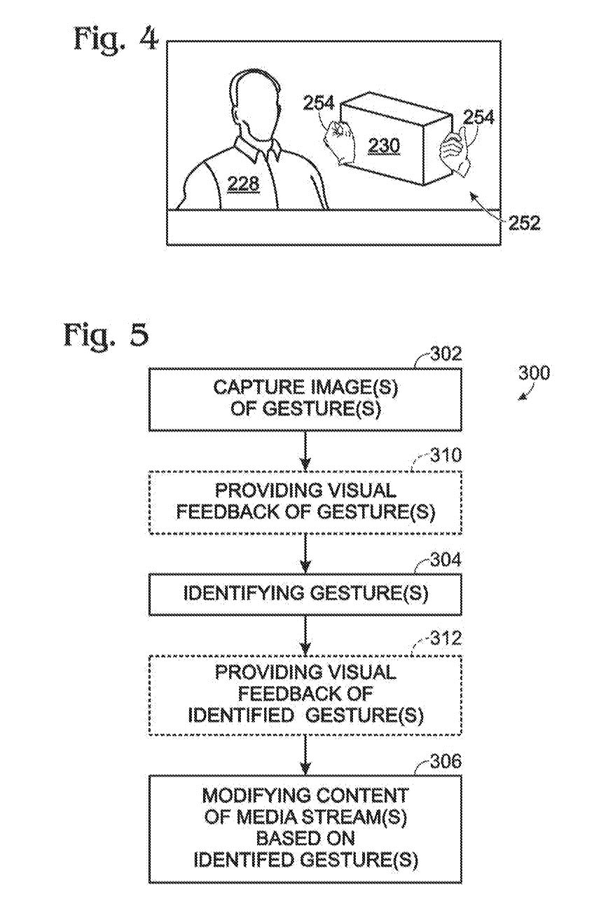

An alternative to visual feedback 238 is shown in FIG. 4 and is generally indicated as 252. Visual feedback 252 is shown in the form of a visual representation of the hands 254 of the first user so that the first user can see what gestures are being made without having to look at his or her hands. The first user also may provide voice commands to complement or supplement gestures 236. For example, first user 232 may say “I want the object to be this big” or “I want the object located here.” Although node 222 is shown to include a single screen, the node may include multiple screens with each screen showing users from a different node but with the same shared content.

Examples of other gestures 236 also are shown in FIG. 3. A framing gesture 244 may position and/or size shared content 230 in an area of the display desired by the first user. A reach in gesture 246 may move the shared content. A grasping gesture 248 may allow first user 232 to grab on to one or more portions of the shared content for further manipulation, such as rotational gesture 237. A pointing gesture 250 may allow the first user to highlight one or more portions of the shared content.

Although specific gestures are shown, nodes 22 and/or 222 may be configured to recognize other gestures. Additionally, although hand gestures are shown in FIG. 3, nodes 22 and/or 222 may be configured to recognize other types of gestures, such as head gestures (e.g., head tilt, etc.), facial expressions (e.g., eye movement, mouth movement, etc.), arm gestures, etc. Moreover, although node 222 is shown to include a screen displaying a single user at a different node with the shared content, the screen may display multiple users at one or more different nodes with the shared content. Furthermore, although node 222 is shown to include a single screen, the node may include multiple screens with some of the screens displaying users from one or more different nodes and the shared content.

FIG. 5 shows an example of a method, which is generally indicated at 300, of modifying content of a media stream based on a user's one or more gestures. While FIG. 5 shows illustrative steps of a method according to one example, other examples may omit, add to, and/or modify any of the steps shown in FIG. 5.

As illustrated in FIG. 5, the method may include capturing an image of a user gesture at 302. The user gesture in the captured image may be identified or recognized at 304. The content of a media stream may be modified based, at least in part, on the identified user gesture at 306.

For example, where the content includes a visual representation of one or more objects, an orientation of that visual representation may be modified based, at least in part, on the identified user gesture. Alternatively, where the media stream includes video of the user and the content is composited within the video of the user, the way the content is displayed within the video of the user may be modified based, at least in part, on the identified user gesture.

Method 300 also may include providing visual feedback to the user of the user gesture at 310 and/or of the identified user gesture at 312. Node 22 also may include computer-readable media comprising computer-executable instructions for modifying content of a media stream using a user gesture, the computer-executable instructions being configured to perform one or more of the steps of method 300 discussed above.

What is claimed is:

1. A node (22) configured to transmit a media stream (24) having content to one or more other nodes (22), comprising:
a media device (36) configured to capture an image of one or more gestures of a user of the node (22);
a media analyzer (38) configured to identify the one or more gestures from the captured image; and
a node manager (44) configured to modify the content of the media stream based, at least in part, on the identified one or more gestures.

2. The node (22) of claim 1, wherein the node manager (44) is configured to send an instruction to the one or more other nodes (22) based, at least in part, on the identified one or more gestures, the instructions configured to modify the content of the media stream (24) received from the node (22) at the one or more other nodes (22).

3. The node (22) of claim 1, wherein the node manager (44) is configured to modify the content of the media stream (24) prior to transmitting that media stream (24) to the one or more other nodes (22).

4. The node (22) of claim 1, wherein the media stream (24) includes video of the user of the node (22) and the content composited within the video of the user of the node (22), and the node manager (44) is configured to modify how the content is displayed within the video of the user of the node (22) in the media stream (24) based, at least in part, on the identified one or more gestures.

5. The node (22) of claim 4, wherein the node manager (44) is configured to modify at least one of a display size and a position of the content within the video of the user of the node (22) in the media stream (24) based, at least in part, on the identified one or more gestures.

6. The node (22) of claim 4, wherein the one or more other nodes (22) include an environmental device, and wherein the node manager (44) is configured to modify a setting of the environmental device based, at least in part, on the identified one or more gestures.

7. The node (22) of claim 1, wherein the media device (36) is further configured to capture audio of one or more voice commands from the user, the media analyzer (38) is further configured to identify the one or more voice commands, and the node manager (44) is further configured to modify the content of the media stream (24) based, at least in part, on the identified one or more voice commands.

8. The node (22) of claim 1, further comprising a feedback system (54) configured to provide visual feedback of the one or more gestures to the user of the node (22).

9. The node (22) of claim 8, wherein the feedback system (54) is further configured to provide visual feedback of the identified one or more gestures to the user of the node (22).

10. A method (300) of modifying content of a media stream (24) based on a user gesture, comprising:
capturing (302) an image of the user gesture;
identifying (304) the user gesture in the captured image; and
modifying (306) the content of the media stream (24) based on the identified user gesture.

11. The method (300) of claim 10, where the content of the media stream (24) includes a visual representation of an object, and wherein modifying the content of the media stream (24) includes modifying the orientation of the object based on the identified user gesture.

12. The method (300) of claim 10, where the media stream (24) includes video of the user and the content composited within the video of the user, and wherein modifying the content of the media stream (24) includes modifying how the content is displayed within the video of the user based on the identified user gesture.

13. The method (300) of claim 10, further comprising providing (310) visual feedback to the user of the user gesture.

14. The method (300) of claim 10, further comprising providing (312) visual feedback to the user of the identified user gesture.

15. Computer-readable media comprising computer-executable instructions for modifying content of a media stream (24) using a user gesture, the computer-executable instructions being configured to:
capture (302) an image of the user gesture;
identify (304) the user gesture in the captured image; and
modify (306) the content of the media stream (24) based on the identified user gesture.
